(19) United States
(12) Patent Application Publication
(10) Pub. No.: US 2025/0051932 A1
(43) Pub. Date: Feb. 13, 2025

(54) SOLID OXIDE ELECTROLYSIS CELL AND CELL ASSEMBLY INCLUDING THE SAME

(71) Applicant: SAMSUNG ELECTRO-MECHANICS CO., LTD., Suwon-si, Gyeonggi-do (KR)

(72) Inventors: Jaeseok Yi, Suwon-si, Gyeonggi-do (KR); Jungdeok Park, Suwon-si, Gyeonggi-do (KR); Hongryul Lee, Suwon-si, Gyeonggi-do (KR); Byungchul Jang, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/277,282

(22) PCT Filed: Jul. 27, 2023
(86) PCT No.: PCT/KR2023/010939

§ 371 Date: Aug. 15, 2023

(30) Foreign Application Priority Data
Dec. 6, 2022 (KR) 10-2022-0168882
Mar. 23, 2023 (KR) 10-2023-0037779

(51) Int. Cl. C25B 1/04; C25B 9/65; C25B 9/77; C25B 13/07

(52) U.S. Cl. CPC C25B 1/04; C25B 9/65; C25B 9/77; C25B 13/07

(57) ABSTRACT

A solid oxide electrolysis cell according to an embodiment includes a solid oxide electrolysis cell including a unit including: a first unit cell including a first fuel electrode, a first electrolyte layer including a solid oxide, and a first air electrode; a second unit cell disposed to be spaced apart from the first unit cell, and including a second fuel electrode, a second electrolyte layer, and a second air electrode; a first porous conductive layer disposed between the first unit cell and the second unit cell; and a separator disposed outside of the unit and having a passage. The second unit cell is disposed on the first unit cell, a stacking order of the first fuel electrode, and the first electrolyte layer, and the first air electrode of the first unit cell is mirror symmetrical to a stacking order of the second fuel electrode, the second electrolyte layer, and the second air electrode of the second unit cell in a stacking direction.

### TECHNICAL FIELD

The present disclosure relates to a solid oxide electrolysis cell and a cell assembly including the same.

### BACKGROUND ART

In general, a solid oxide electrolysis cell (SOEC) is a device that generates hydrogen by electrolyzing water, and it can produce green hydrogen using electricity generated by renewable energy such as solar and wind power, which is essential for the future carbon neutrality and hydrogen economy. In particular, the SOEC is an environmentally-friendly energy conversion device with high efficiency and carbon-free due to high temperature driving.

A unit cell of the SOEC may include a fuel electrode, an electrolyte layer, and an air electrode. A plurality of solid oxide electrolysis cells can be stacked to form a cell assembly. In the SOEC, the fuel electrode may refer to a cathode, and the air electrode may refer to an anode.

The electrode reaction in SOEC is an inverse reaction of those in a solid oxide fuel cell (SOFC), so the structure of the SOEC and the SOFC are largely similar.

Therefore, like the SOFC, the SOEC can be electrically connected in series with each other as unit cells and bipolar plates are stacked alternately. However, the SOFC, which is a power generation device, can obtain a high voltage by collecting the voltage generated by the unit cells, so a series connection structure is advantageous. However, In the SOEC, excessive voltage can be applied to some of the unit cells during turn-on and turn-off, or when momentary voltage fluctuations occur, which can damage the unit cells.

### DISCLOSURE OF INVENTION

### Technical Problem

The present disclosure attempts to provide a solid oxide electrolysis cell and a cell assembly including the same, which can minimize thickness and can simultaneously prevent damage by local high voltage.

### Solution to Problem

A solid oxide electrolysis cell according to an embodiment includes a unit including a first unit cell including a first fuel electrode, a first electrolyte layer including a solid oxide, and a first air electrode, a second unit cell disposed to be spaced apart from the first unit cell, and including a second fuel electrode, a second electrolyte layer, and a second air electrode, and a first porous conductive layer disposed between the first unit cell and the second unit cell, and a separator disposed outside of the unit and having a passage. The second unit cell is disposed on the first unit cell, a stacking order of the first fuel electrode, the first electrolyte layer, and the first air electrode of the first unit cell is mirror symmetrical to a stacking order of the second fuel electrode, the second electrolyte layer, and the second air electrode of the second unit cell in a stacking direction.

The first air electrode and the second air electrode may be respectively opposite to both sides of the first porous conductive layer.

The separator may include the first separator adjacent to the first fuel electrode, and the second separator adjacent to the second fuel electrode.

The unit may further include a second porous conductive layer disposed between the first fuel electrode and the first separator, and a third porous conductive layer disposed between the second fuel electrode and the second separator.

The first porous conductive layer, the second porous conductive layer, and the third porous conductive layer may include one of a foam shape, a mesh shape, a felt shape, or a weaving material shape.

The first air electrode and the second air electrode may be respectively contacted with both sides of the first porous conductive layer.

The unit may further include a first conductive adhesive member disposed between the first air electrode and one surface of the first porous conductive layer, and a second conductive adhesive member disposed between the second air electrode and the other surface of the first porous conductive layer.

The separator may include an insulator.

The first fuel electrode and the second fuel electrode may be respectively opposite to both sides of the first porous conductive layer.

A cell assembly according to an embodiment include a stack including a plurality of solid oxide electrolysis cells stacked on each other, and an electrical wire unit connecting the plurality of solid oxide electrolysis cells. The solid oxide electrolysis cell includes a unit including a first unit cell including a first fuel electrode and a first air electrode opposite to each other, and a first electrolyte layer disposed between the first fuel electrode and the first air electrode, and includes a solid oxide, a second unit cell disposed to be spaced apart from the first unit cell, and including a second fuel electrode and a second air electrode opposite to each other, and a second electrolyte layer disposed between the second fuel electrode and the second air electrode, and a first porous conductive layer disposed between the first unit cell and the second unit cell, and a separator disposed outside of the unit and having a passage. The second unit cell is disposed on the first unit cell. A stacking order of the first fuel electrode, the first electrolyte layer, and the first air electrode of the first unit cell is mirror symmetrical to a stacking order of the second fuel electrode, the second electrolyte layer, and the second air electrode of the second unit cell in a stacking direction.

The first air electrode and the second air electrode may be respectively opposite to both sides of the first porous conductive layer.

The separator may include the first separator adjacent to the first fuel electrode, and the second separator adjacent to the second fuel electrode.

The unit may further include a second porous conductive layer disposed between the first fuel electrode and the first separator, and a third porous conductive layer disposed between the second fuel electrode and the second separator.

The electrical wire unit may connect each of the units of the plurality of solid oxide electrolysis cells in parallel, the electrical wire unit may include a first electrical wire connected with the plurality of first porous conductive layers, and a second electrical wire connected with the plurality of the second porous conductive layers and the plurality of the third porous conductive layers.

The first electrical wire may connect the plurality of first porous conductive layers together.

The first electrical wire may include a plurality of sub-electrical wires respectively connected to the plurality of first porous conductive layers.

The electrical wire unit may further include a plurality of circuit breakers that are installed in the first electrical wire or the second electrical wire, and are configured to stop operation of each of the plurality of units, respectively.

The cell assembly may further include a case surrounding the stack and to be spaced apart from the stack to have an air moving path for supplying air to the first air electrode and the second air electrode, and the electrical wire unit may be disposed on the air moving path.

A cell assembly according to an embodiment include a first unit cell including a first fuel electrode, a first air electrode, and a first electrolyte layer disposed between the first fuel electrode and the first air electrode and including a solid oxide; a second unit cell including a second fuel electrode, a second air electrode, and a second electrolyte layer disposed between the second fuel electrode and the second air electrode; a separator disposed between the first unit cell and the second unit cell and having a passage; a first porous conductive layer disposed below the first unit cell or on the second unit cell; and an electrical wire unit connected to the first unit cell, the second unit cell, and the first porous conductive layer. A stacking order of the first fuel electrode, the first electrolyte layer, and the first air electrode of the first unit cell is mirror symmetrical to a stacking order of the second fuel electrode, the second electrolyte layer, and the second air electrode of the second unit cell in a stacking direction.

The cell assembly may further include a second porous conductive layer disposed between the first fuel electrode and the separator; and a third porous conductive layer disposed between the second fuel electrode and the separator, The first fuel electrode may be disposed between the second porous conductive layer and the first electrolyte layer, and the second fuel electrode may be disposed between the third porous conductive layer and the second electrolyte layer.

The cell assembly may further include a second porous conductive layer disposed between the first air electrode and the separator; and a third porous conductive layer disposed between the second air electrode and the separator. The first air electrode may be disposed between the second porous conductive layer and the first electrolyte layer, and the second air electrode may be disposed between the third porous conductive layer and the second electrolyte layer.

The first porous conductive layer may be in contact with the first unit cell or the second unit cell.

The cell assembly may further include a conductive adhesive member to connect the first porous conductive layer to the first unit cell or the second unit cell.

### Advantageous Effects of Invention

According to embodiments, by tying two unit cells together into a unit, installing a separator on the outside of the unit to create a solid oxide electrolysis cell, and creating a stack by stacking solid oxide electrolysis cells, the number of separators used in the stack can be reduced to minimize the thickness of the stack and the cell assembly including it.

In addition, by electrically connecting each unit of a plurality of solid oxide electrolysis cells to each other in parallel, high voltage may not be applied to the unit. Thus, local high voltage that can occur instantaneously can be prevented from being applied to the unit.

In addition, by installing a plurality of circuit breakers connected to each of the plurality of units, the unit of each of the solid oxide electrolysis cells can be turned on and off individually, so that only the voltage of the potentially damaged unit can be adjusted, thereby improving the long-term reliability of the cell assembly.

However, it will be appreciated that the effects of the embodiments are not limited to those described above and may be expanded in various ways without departing from the spirit and scope of the present invention.

### BRIEF DESCRIPTION OF DRAWINGS

FIG. 1 is a schematic perspective view of a solid oxide electrolysis cell according to an embodiment.

FIG. 2 is an explode perspective view of FIG. 1.

FIG. 3 is a cross-sectional view taken along III-III′ line of FIG. 1.

FIG. 4 is a schematic cross-sectional view of a solid oxide electrolysis cell according to an embodiment.

FIG. 5 is a schematic cross-sectional view of a solid oxide electrolysis cell according to an embodiment.

FIG. 6 is a schematic perspective view of a cell assembly according to an embodiment.

FIG. 7 is an explode perspective view of FIG. 6.

FIG. 8 is a cross-sectional view taken along VIII-VIII′ line of FIG. 6.

FIG. 9 is an exploded perspective view of a cell assembly according to another embodiment.

### MODE FOR THE INVENTION

Hereinafter, an embodiment of the present invention will be described in detail with reference to the accompanying drawings so that a person of an ordinary skill in the art can easily make it. As those skilled in the art would realize, the described embodiments may be modified in various different ways, all without departing from the spirit or scope of the present invention.

Accordingly, the drawings and description are to be regarded as illustrative in nature and not restrictive, and like reference numerals designate like constituent element throughout the specification.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present invention.

Because the size and thickness of each configuration shown in the drawings are arbitrarily shown for better understanding and ease of description, the present invention is not limited thereto. In the drawings, the thickness of layers, films, panels, regions, etc., are exaggerated for clarity. In the drawings, the thickness of layers and regions may be exaggerated for better understanding and ease of description.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means disposed on, above, or below the object portion and does not necessarily mean disposed on the upper side of the object portion based on a gravitational direction.

In addition, unless explicitly described to the contrary, the word “comprise”, and variations such as “comprises” or “comprising”, will be understood to imply the inclusion of stated elements but not the exclusion of any other elements.

Throughout the specification, the phrase “on a plane” means viewing the object portion from the top, and the phrase “on a cross-section” means viewing a cross-section of which the object portion that vertically cut from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

Hereinafter, various embodiments and variations are described in detail with reference to the drawings.

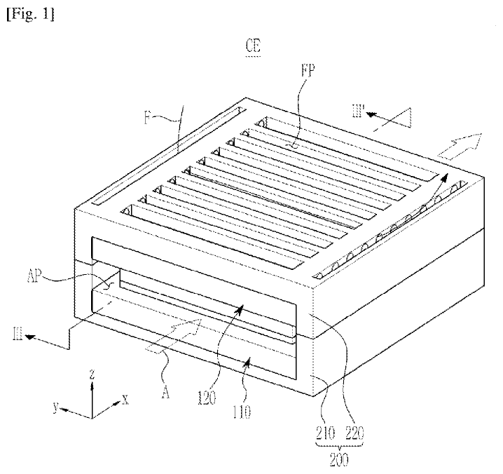

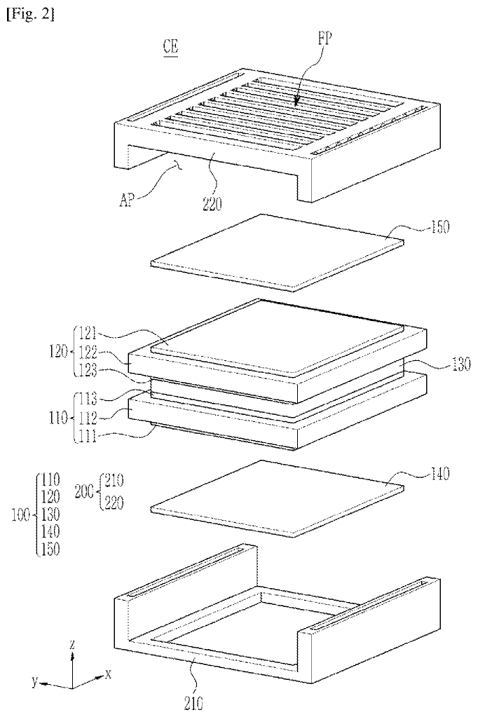

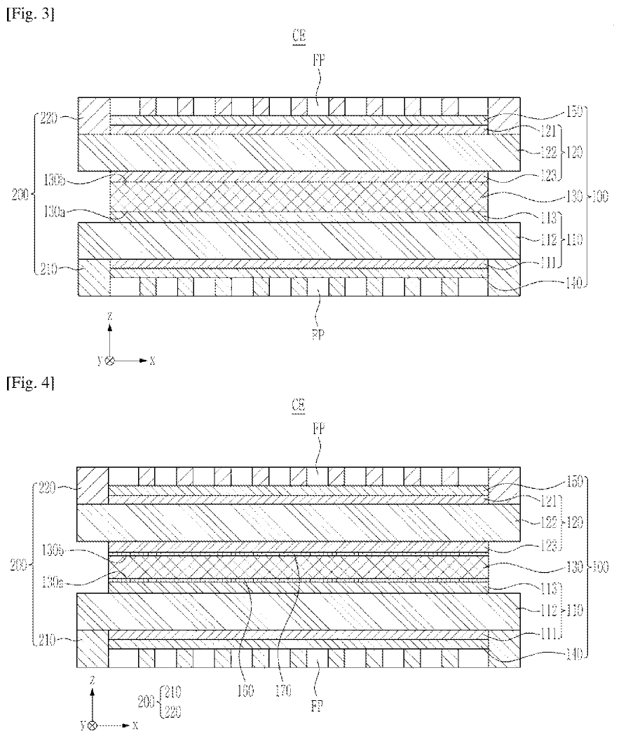

FIG. 1 is a schematic perspective view of a solid oxide electrolysis cell according to an embodiment. FIG. 2 is a explode perspective view of FIG. 1. FIG. 3 is a cross-sectional view taken along III-III′ line of FIG. 1.

As shown in FIG. 1 to FIG. 3, a solid oxide electrolysis cell CE according to an embodiment includes a unit 100, and a separator 200.

The unit 100 may include a first unit cell 110, a second unit cell 120, a first porous conductive layer 130, a second porous conductive layer 140, and a third porous conductive layer 150.

The first unit cell 110 and the second unit cell 120 may be disposed in mirror symmetry with respect to each other reference to the first porous conductive layer 130. Here, mirror symmetry means that the first unit cell 110 and the second unit cell 120 are disposed in a shape as if they are reflected in a mirror.

The first unit cell 110 may include a first fuel electrode 111, a first electrolyte layer 112, and a first air electrode 113. The first fuel electrode 111 and the first air electrode 113 may be disposed in opposite direction, and the first electrolyte layer 112 may be disposed between the first fuel electrode 111 and the first air electrode 113.

The first fuel electrode 111 has a flat plate shape and may be supplied with fuel gas F such as water (H₂O) in a reducing atmosphere to generate hydrogen gas and oxygen ions through electrolysis. Specifically, the first fuel electrode 111 may include a fuel electrode layer and a fuel function layer. The fuel electrode layer occupies most of the area of the first fuel electrode 111 and is the layer where the electrode reaction occurs. The fuel function layer is disposed between the fuel electrode layer and the first electrolyte layer 200, and can reduce the contact resistance of the fuel electrode layer and the first electrolyte layer 200 by reducing the surface roughness. In addition, the fuel function layer can increase the reaction area, thereby improving performance.

The first electrolyte layer 112 has a flat plate shape and can transfer oxygen ions generated from the first fuel electrode 111 to the first air electrode 113. Specifically, the first electrolyte layer 112 may include a main electrode layer and a reaction prevention layer. The main electrolyte layer occupies most of the area of the first electrolyte layer 112 and is the layer where oxygen ions are transferred. The reaction prevention layer is disposed between the main electrolyte layer and the first air electrode 113 and is a layer preventing gas reactions that may occur unnecessarily between the main electrolyte layer and the first air electrode 113.

The first air electrode 113 has a flat plate shape, and in an oxidizing atmosphere supplied with a gas A such as oxygen, oxygen ions transferred from the first electrolyte layer 112 can be oxidized to generate oxygen gas. Specifically, the air electrode 113 may include an air electrode layer and an air function layer. The air electrode layer occupies most of the area of the first air electrode 113 and is the layer where the electrode reaction occurs. The air functional layer is disposed between the air electrode layer and the first electrolyte layer 112 and can extend the catalyst reaction area in the direction of the air electrode layer to improve reactivity in the air electrode layer.

The first air electrode 113 can be formed by sintering a highly electronically conductive lanthanum manganite ((La_{0.84}Sr_{0.16})MnO₃) or the like. However, the air electrode is not limited thereto, and can be made of a variety of materials.

The second unit cell 120 may be spaced apart from the first unit cell 110. The second unit cell 120 may include a second air electrode 123, a second electrolyte layer 122, and a second fuel electrode 121. The second fuel electrode 121 and the second air electrode 123 may be disposed in opposite directions, and the second electrolyte layer 122 may be disposed between the second fuel electrode 121 and the second air electrode 123.

The second fuel electrode 121 includes the same material as the first fuel electrode 111 and may have the same structure. The second electrolyte layer 122 includes the same material as the first electrolyte layer 112 and may have the same structure. The second air electrode 123 includes the same material as the first air electrode 113 and may have the same structure.

The first porous conductive layer 130 is disposed between the first unit cell 110 and the second unit cell 120 to transport air and can perform electrical conduction. The first porous conductive layer 130 may have a foam shape, a mesh shape, a felt shape, or a weaving material shape, but is not necessarily limited thereto. The first porous conductive layer 130 may include, but is not necessarily limited to, any of platinum (Pt), palladium (Pd), rhodium (Rh), silver (Ag), and gold (Au).

The first air electrode 113 and the second air electrode 123 may face opposite sides 130a and 130b of the first porous conductive layer 130, respectively. At this time, the first air pore 113 and the second air pore 123 may respectively contact two sides 130a and 130b of the first porous conductive layer 130. Even though the first air electrode 113 and the second air electrode 123 are respectively in contact with two sides 130a and 130b of the first porous conductive layer 130, a gas can be generated and escape.

Along the height direction Z, the first unit cell 110 may be stacked in the order of the first fuel pole 111, the first electrolyte layer 112, and the first air pole 113. and the second unit cell 120 may be stacked in the order of the second air electrode 123, the second electrolyte layer 122, and the second fuel electrode 121.

That is, along the height direction Z, it can be stacked in the order of the first fuel electrode 111, the first electrolyte layer 112, the first air electrode 113, the first porous conductive layer 130, the second air electrode 123, the second electrolyte layer 122, and the second fuel electrode 121.

Therefore, the first unit cell 110 and the second unit cell 120 may be disposed in mirror symmetry with respect to each other with reference to the first porous conductive layer 130.

The second porous conductive layer 140 is disposed between the first fuel electrode 111 and the first separator 210 to transport a fuel and can perform electrical conduction. The second porous conductive layer 140 may have a foam shape, a mesh shape, a felt shape, or a weaving material shape, and may include, but is not necessarily limited to, any of platinum (Pt), palladium (Pd), rhodium (Rh), silver (Ag), and gold (Au).

The third porous conductive layer 150 is disposed between the second fuel electrode 121 and the second separator 220 to transport a fuel and can perform electrical conduction. The third porous conductive layer 150 may have a foam shape, a mesh shape, a felt shape, or a weaving material shape, and may include, but is not necessarily limited to, any of platinum (Pt), rhodium (Rh), silver (Ag), and gold (Au).

The separator 200 is disposed on both outer sides of the unit 100, and may have passages AP and FP. These separator plates 200 are disposed between adjacent units 100 to evenly distribute the air A and fuel gas F supplied to the first unit cell 110 and the second unit cell 120 using the passages AP and FP over the surfaces of the first unit cell 110 and the second unit cell 120 and prevent the air A and fuel gas F from mixing with each other. In addition, the separator 200 may further include a sealant (not shown) that prevents air A and fuel gas F from escaping to the outside.

The separator 200 may include a first separator plate 210 disposed adjacent to the first fuel electrode 111, and a second separator 220 disposed adjacent to the second fuel electrode 121. The first separator 210 and the second separator 220 may include insulators. These insulators may include ceramics, etc.

The separator 200 surrounds the unit 100 entirely, and may have an air passage AP for transporting air A and a fuel passage FP for transporting fuel gas F. In the present embodiment, air passages APs are formed on the sidewalls of the separator 200 and fuel passages FPs are formed on the top and bottom surfaces of the separator 200, but are not necessarily limited to thereto, and various structures are possible.

The first fuel electrode 111 and the second fuel electrode 121 are disposed adjacent to the first separator 210 and the second separator 220, which have the fuel passages FPs, respectively, so that the fuel gas F can be easily transferred.

Meanwhile, in the above embodiment, the first air electrode and the second air electrode are each in contact with two sides of the first porous conductive layer, but another embodiment is also possible in which separate conductive contact members are used to bond each of the first and second air electrodes and both sides of the first porous conductive layer to each other.

Hereinafter, with reference to FIG. 4, a solid oxide electrolysis cell according to another embodiment will be described in detail.

FIG. 4 is a schematic cross-sectional view of a solid oxide electrolysis cell according to an embodiment.

Another embodiment shown in FIG. 4 is substantially equivalent to an embodiment shown in FIGS. 1 to 3, except for a first conductive contact member and a second conductive contact member, and repeated description will be omitted.

As shown in FIG. 4, a solid oxide electrolysis cell according to another embodiment includes a unit 100 and a separator 200.

The unit 100 may include a first unit cell 110, a second unit cell 120, a first porous conductive layer 130, a second porous conductive layer 140, and a third porous conductive layer 150, a first conductive adhesive member 160, and a second conductive adhesive member 170.

The first conductive adhesive member 160 may be disposed between a first air electrode 113 and one surface 130a of the first porous conductive layer 130. Thus, the first conductive adhesive member 160 can bond the first air electrode 113 and one surface 130a of the first porous conductive layer 130 to each other while electrically connecting the first air electrode 113 and the first porous conductive layer 130 to each other. Like this, by installing the first conductive adhesive member 160, the adhesion and conductivity between the first air electrode 113 and the first porous conductive layer 130 can be improved, thereby improving the reliability of the solid oxide electrolysis cell CE.

The second conductive adhesive member 170 may be disposed between the second air electrode 123 and the other surface 130b of the first porous conductive layer 130. Thus, the second conductive adhesive member 170 can bond the second air electrode 123 and the other surface 130b of the first porous conductive layer 130 to each other while electrically connecting the first air electrode 123 and the first porous conductive layer 130 to each other. Like this, by installing the second conductive adhesive member 170, the adhesion and conductivity between the second air electrode 123 and the first porous conductive layer 130 can be improved, thereby improving the reliability of the solid oxide electrolysis cell CE.

Meanwhile, in the above embodiment, the first air electrode and the second air electrode are each opposite to two sides of the first porous conductive layer, but another embodiment is possible in which the first fuel electrode and the second fuel electrode are each opposite two sides of the first porous conductive layer.

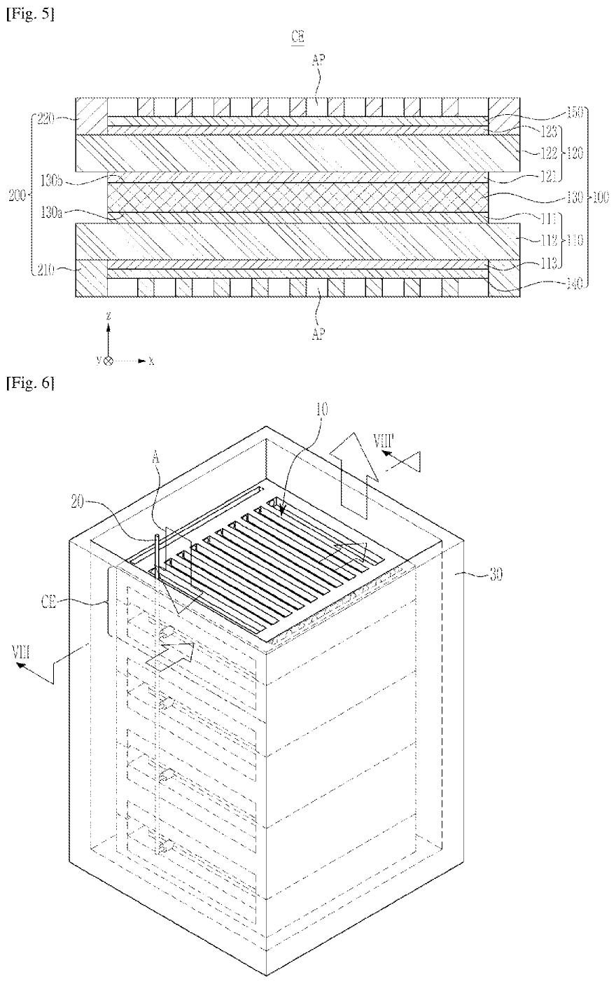

Hereinafter, with reference to FIG. 5, a solid oxide electrolysis cell according to another embodiment will be described in detail.

FIG. 5 is a schematic cross-sectional view of a solid oxide electrolysis cell according to an embodiment.

Another embodiment shown in FIG. 5 is substantially equivalent to an embodiment shown in FIGS. 1 to 3, except for a disposition direction of a first unit cell and a second unit cell, and repeated description will be omitted.

As shown in FIG. 5, a solid oxide electrolysis cell according to another embodiment includes a unit 100 and a separator 200.

The unit 100 may include a first unit cell 110, a second unit cell 120, a first porous conductive layer 130, a second porous conductive layer 140, and a third porous conductive layer 150.

The first unit cell 110 and the second unit cell 120 may be disposed in mirror symmetry with respect to each other with reference to the first porous conductive layer 130.

Along the height direction Z, the first unit cell 110 can be stacked in the order of the first air electrode 113, the first electrolyte layer 112, and the first fuel electrode 111, and the second unit cell 120 can be stacked in the order of the second fuel electrode 121, the second electrolyte layer 122, and the second air electrode 123. Thus, the first fuel electrode 111 and the second fuel electrode 121 are opposite the two sides 130a and 130b of the first porous conductive layer 130, respectively, and can contact the two sides 130a and 130b of the first porous conductive layer 130, respectively.

The separator 200 surrounds the unit 100 entirely, and may have the air passage AP for transporting air A and the fuel passage FP for transporting fuel gas F.

The first separator 210 may be connected to the first air electrode 113 via the second porous conductive layer 140, and the second separator 220 may be connected to the second air electrode 123 via the third porous conductive layer 150.

The first air electrode 113 and the second air electrode 123 are disposed adjacent to the first separator 210 and the second separator 220, which have the air passage AP, respectively, so that the air A can be easily transferred.

Hereinafter, a cell assembly including the solid oxide electrolysis cell of FIGS. 6 to 8 will be described in detail with reference to the drawings.

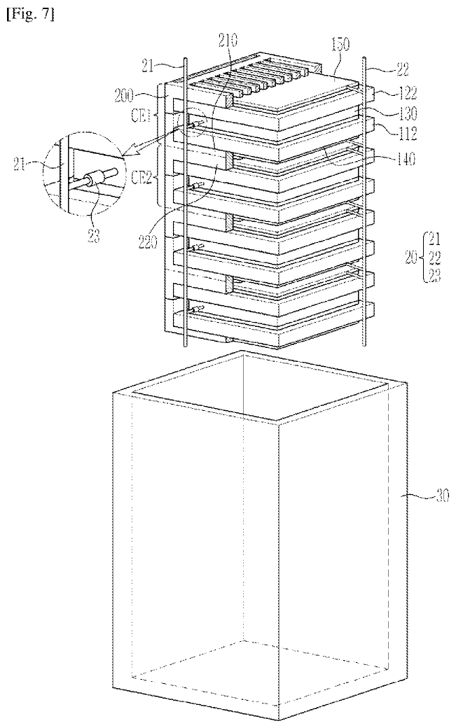

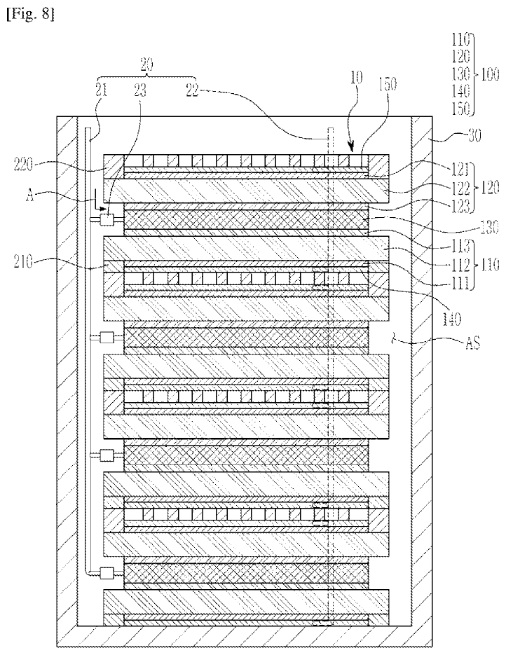

FIG. 6 is a schematic perspective view of a cell assembly according to an embodiment, FIG. 7 is an explode perspective view of FIG. 6, and FIG. 8 is a cross-sectional view taken along VIII-VIII′ line of FIG. 6.

As shown in FIG. 6 to FIG. 8, a cell assembly according to an embodiment includes a stack 10, an electrical wire unit 20, and a case 30.

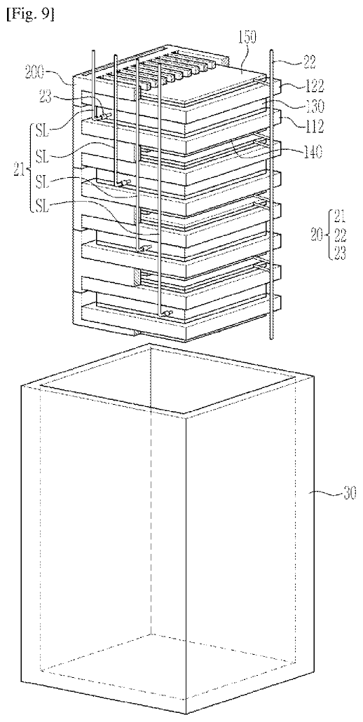

The stack 10 may include a plurality of solid oxide electrolysis cells CEs that are stacked. Each solid oxide electrolysis cell CE includes a unit 100, and a separator 200 (see FIG. 9). A detailed description of the solid oxide electrolysis cell CE has been described in detail above and will be omitted here.

The stack 10 of the present embodiment includes, but is not necessarily limited thereto, four stacked solid oxide electrolysis cells CEs, and various numbers of solid oxide electrolysis cells CEs may be stacked.

In this case, a first separator 210 of an adjacent first solid oxide electrolysis cell CE1 and a second separator 220 of a second solid oxide electrolysis cell CE2 are connected to each other and may be manufactured as an integral type. Thus, the first separator 210 of the first solid oxide electrolysis cell CE1 can be used as the second separator 220 of the second solid oxide electrolysis cell CE2.

Like this, since the first air electrode 113 and the second air electrode 123 are disposed opposite the two sides 130a and 130b of the first porous conductive layer 130, it is not necessary to install a separate separator adjacent to the first air electrode 113 and the second air electrode 123. Thus, the separator 200 is only required at locations adjacent to the first fuel electrode 111 and the second fuel electrode 121, allowing the separator 200 to be thinner in thickness.

In this way, by grouping the first unit cell 110 and the second unit cell 120 into a single unit 100, creating the solid oxide electrolysis cell CE by installing separators 200 on both outer sides of the unit 100, and stacking solid oxide electrolysis cells CE to create the stack 10, thereby reducing the number of separators 200 used in the stack 10 while simultaneously reducing the thickness of the separators 200, the thickness of the stack and the cell assembly including thereof can be minimized.

The electrical wire unit 20 may electrically connect each unit 100 of the plurality of solid oxide electrolysis cells CEs in parallel.

The electrical wire unit 20 may include a first electrical wire 21, a second electrical wire 22, and a plurality of circuit breakers 23.

The first electrical wire 21 may connect the plurality of first porous conductive layers 130 together.

The second electrical wire 22 may be connected to the plurality of second porous conductive layers 140 and the plurality of third porous conductive layers 150.

In this way, the electrical wire unit 20 may not apply high voltage to the unit 100 by electrically connecting each unit 100 of the plurality of solid oxide electrolysis cells CEs in parallel. Thus, local high voltage that can occur instantaneously can be prevented from being applied to the unit 100.

Further, the plurality of solid oxide electrolysis cells CEs may be electrically connected in parallel, so that even if damage occurs to some of the solid oxide electrolysis cells CEs, only the corresponding solid oxide electrolysis cells CEs can be shut down and the cell assembly can be powered by the remaining solid oxide electrolysis cells CEs without replacing the entire stack. Therefore, it is possible to reduce the cost of maintaining the cell assembly.

The plurality of circuit breakers 23 are installed in the first electrical wire 21 or the second electrical wire 22 and can stop the operation of the plurality of units 100, respectively. For example, such a circuit breaker 23 may include a fuse or the like.

Like this, by installing the plurality of circuit breakers 23 connected with each of the plurality of units 100, the units 100 of each solid oxide electrolysis cell CE can be turned on and off individually, so that only the voltage of the potentially damaged unit 100 can be adjusted, thereby improving the long-term reliability of the cell assembly.

The case 30 may be installed around the stack 10. The case 30 may be spaced apart from the stack 10 and have an air moving path AS therein. The air moving path AS can supply and exhaust air A to the first air electrode 113 and the second air electrode 123. The electrical wire unit 20 may be disposed in such air moving path AS.

Meanwhile, in the cell assembly of the above embodiment, the first electrical wire connects the plurality of first porous conductive layers together, but another embodiment is possible in which the first electrical wire includes a plurality of sub-electrical wires each connected with the plurality of first porous conductive layers.

Hereinafter, with reference to FIG. 9, a cell assembly according to another embodiment will be described in detail.

FIG. 9 is an exploded perspective view of a cell assembly according to another embodiment.

Another embodiment shown in FIG. 9 is substantially equivalent to the embodiment shown in FIGS. 6 to 8, except for a structure of the first electrical wire, and repeated description will be omitted.

As shown in FIG. 9, a cell assembly according to an embodiment includes a stack 10 (see FIG. 8), an electrical wire unit 20, and a case 30.

The electrical wire unit 20 may electrically connect each unit 100 of the plurality of solid oxide electrolysis cells CEs in parallel. The electrical wire unit 20 may include a first electrical wire 21, a second electrical wire 22, and a plurality of circuit breakers 23.

The first electrical wire 21 may include a plurality of sub-electrical wires SL respectively connected to the plurality of first porous conductive layers 130. Four sub-electrical wires (SLs) are shown in the present embodiment, but it is not necessarily limited thereto.

Like this, the first electrical wire 21 includes a plurality of sub-electrical wires SLs respectively connected to the plurality of first porous conductive layers 130, so it is possible to individually drive each unit 100 of the plurality of solid oxide electrolysis cells CEs, so that only the voltage of the potentially damaged unit can be adjusted, thereby improving the long-term reliability of the cell assembly.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

1. A solid oxide electrolysis cell, comprising:
a unit including:
a first unit cell including a first fuel electrode, a first electrolyte layer including a solid oxide, and a first air electrode;
a second unit cell disposed to be spaced apart from the first unit cell, and including a second fuel electrode, a second electrolyte layer, and a second air electrode; and
a first porous conductive layer disposed between the first unit cell and the second unit cell; and
a separator disposed outside of the unit and having a passage,
wherein the second unit cell is disposed on the first unit cell, and a stacking order of the first fuel electrode, the first electrolyte layer, and the first air electrode of the first unit cell is mirror symmetrical to a stacking order of the second fuel electrode, the second electrolyte layer, and the second air electrode of the second unit cell in a stacking direction.

2. The solid oxide electrolysis cell of claim 1, wherein
the first air electrode and the second air electrode are respectively opposite to both sides of the first porous conductive layer.

3. The solid oxide electrolysis cell of claim 2, wherein
the separator includes:
a first separator adjacent to the first fuel electrode; and
a second separator adjacent to the second fuel electrode.

4. The solid oxide electrolysis cell of claim 3, wherein
the unit further includes:
a second porous conductive layer disposed between the first fuel electrode and the first separator; and
a third porous conductive layer disposed between the second fuel electrode and the second separator.

5. The solid oxide electrolysis cell of claim 4, wherein
the first porous conductive layer, the second porous conductive layer, and the third porous conductive layer include one of a foam shape, a mesh shape, a felt shape, or a weaving material shape.

6. The solid oxide electrolysis cell of claim 2, wherein
the first air electrode and the second air electrode are respectively contacted with both sides of the first porous conductive layer.

7. The solid oxide electrolysis cell of claim 2, wherein
the unit further includes:
a first conductive adhesive member disposed between the first air electrode and one surface of the first porous conductive layer; and
a second conductive adhesive member disposed between the second air electrode and the other surface of the first porous conductive layer.

8. The solid oxide electrolysis cell of claim 1, wherein
the separator includes an insulator.

9. The solid oxide electrolysis cell of claim 1, wherein
the first fuel electrode and the second fuel electrode are respectively opposite to both sides of the first porous conductive layer.

10. A cell assembly, comprising:
a stack including a plurality of solid oxide electrolysis cells stacked on each other; and
an electrical wire unit connecting the plurality of solid oxide electrolysis cells,
wherein each solid oxide electrolysis cell includes:
a unit including:
a first unit cell including a first fuel electrode and a first air electrode opposite to each other, and a first electrolyte layer disposed between the first fuel electrode and the first air electrode and including a solid oxide;
a second unit cell disposed to be spaced apart from the first unit cell, and including a second fuel electrode and a second air electrode opposite to each other, and a second electrolyte layer disposed between the second fuel electrode and the second air electrode; and
a first porous conductive layer disposed between the first unit cell and the second unit cell; and
a separator disposed outside of the unit and having a passage,
wherein the second unit cell is disposed on the first unit cell, and a stacking order of the first fuel electrode, the first electrolyte layer, and the first air electrode of the first unit cell is mirror symmetrical to a stacking order of the second fuel electrode, the second electrolyte layer, and the second air electrode of the second unit cell in a stacking direction.

11. The cell assembly of claim 10, wherein
the first air electrode and the second air electrode are respectively opposite to both sides of the first porous conductive layer.

12. The cell assembly of claim 11, wherein
the separator includes:
a first separator adjacent to the first fuel electrode; and
a second separator adjacent to the second fuel electrode.

13. The cell assembly of claim 12, wherein
the unit further includes:
a second porous conductive layer disposed between the first fuel electrode and the first separator; and
a third porous conductive layer disposed between the second fuel electrode and the second separator.

14. The cell assembly of claim 13, wherein
the electrical wire unit connects each of the unit of the plurality of solid oxide electrolysis cells in parallel, and
the electrical wire unit includes:
a first electrical wire connected with the plurality of first porous conductive layers; and
a second electrical wire connected with the plurality of second porous conductive layers and the plurality of third porous conductive layers.

15. The cell assembly of claim 14, wherein
the first electrical wire connects the plurality of first porous conductive layers together.

16. The cell assembly of claim 14, wherein
the first electrical wire includes a plurality of sub-electrical wires respectively connected to the plurality of first porous conductive layers.

17. The cell assembly of claim 14, wherein
the electrical wire unit further includes a plurality of circuit breakers that are installed in the first electrical wire or the second electrical wire, and are configured to stop operation of the plurality of units, respectively.

18. The cell assembly of claim 14, further comprising
a case surrounding the stack and to be spaced apart from the stack so as to have an air moving path for supplying air to the first air electrode and the second air electrode, and
the electrical wire unit is disposed on the air moving path.

19. A cell assembly, comprising:
a first unit cell including a first fuel electrode, a first air electrode, and a first electrolyte layer disposed between the first fuel electrode and the first air electrode and including a solid oxide;
a second unit cell including a second fuel electrode, a second air electrode, and a second electrolyte layer disposed between the second fuel electrode and the second air electrode;
a separator disposed between the first unit cell and the second unit cell and having a passage;
a first porous conductive layer disposed below the first unit cell or on the second unit cell; and
an electrical wire unit connected to the first unit cell, the second unit cell, and the first porous conductive layer,
wherein a stacking order of the first fuel electrode, the first electrolyte layer, and the first air electrode of the first unit cell is mirror symmetrical to a stacking order of the second fuel electrode, the second electrolyte layer, and the second air electrode of the second unit cell in a stacking direction.

20. The cell assembly of claim 19, further comprising:
a second porous conductive layer disposed between the first fuel electrode and the separator; and
a third porous conductive layer disposed between the second fuel electrode and the separator,
wherein the first fuel electrode is disposed between the second porous conductive layer and the first electrolyte layer, and the second fuel electrode is disposed between the third porous conductive layer and the second electrolyte layer.

21. The cell assembly of claim 19, further comprising:
a second porous conductive layer disposed between the first air electrode and the separator; and
a third porous conductive layer disposed between the second air electrode and the separator,
wherein the first air electrode is disposed between the second porous conductive layer and the first electrolyte layer, and the second air electrode is disposed between the third porous conductive layer and the second electrolyte layer.

22. The cell assembly of claim 19, wherein the first porous conductive layer is in contact with the first unit cell or the second unit cell.

23. The cell assembly of claim 19, further comprising a conductive adhesive member to connect the first porous conductive layer to the first unit cell or the second unit cell.
